(19) United States
(12) Patent Application Publication
(10) Pub. No.: US 2018/0341449 A1
(43) Pub. Date: Nov. 29, 2018

(54) DISPLAY CONTROL METHOD, ORDER MANAGEMENT METHOD, DISPLAY CONTROL DEVICE, AND RECORDING MEDIUM

(71) Applicant: FUJITSU LIMITED, Kawasaki-shi (JP)

(72) Inventors: Satoshi Yoshimura, Kouto (JP); Hiroshi Inoue, Ota (JP)

(73) Assignee: FUJITSU LIMITED, Kawasaki-shi (JP)

(21) Appl. No.: 15/972,545

(22) Filed: May 7, 2018

(30) Foreign Application Priority Data
May 26, 2017 (JP) 2017-105040

(51) Int. Cl. G06F 3/147; G09F 23/06

(52) U.S. Cl. CPC G06F 3/147; G06Q 20/204; G09F 23/06

(57) ABSTRACT

A display control method includes: receiving registration of a target image to be displayed on a display of a container, by a processor; upon acquisition of identification information of a container or a display of the container, transmitting the registered image to a destination associated with the identification information, by the processor; and displaying the image on the display of the container, by the processor.

### CROSS REFERENCE TO RELATED APPLICATION

This application is based upon and claims the benefit of priority of the prior Japanese Patent Application No. 2017-105040, filed on May 26, 2017, the entire contents of which are incorporated herein by reference.

### FIELD

The embodiment discussed herein is related to a display control method, an order management method, a display control device, and a recording medium.

### BACKGROUND

There are various methods for an operator of a shop to send information to visitors who visit the shop. For example, such various methods include push notification for pushing information to mobile terminals of visitors, distribution of information using social networking service (SNS), and distribution of e-mail newsletters to e-mail addresses of individual visitors. Further, there is a method of sending information by advertisement on a paper medium or information put on a message board.

However, is the related technology of sending information to visitors who visit a store, because it is a method of sending information to many and unspecified people, there is a problem that it is not possible to send individual pieces of information to each of individual visitors.

### SUMMARY

According to an aspect of the embodiment, a display control method includes: receiving registration of a target image to be displayed on a display of a container, by a processor; upon acquisition of identification information of a container or a display of the container, transmitting the registered image to a destination associated with the identification information, by the processor; and displaying the image on the display of the container, by the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of a display control system including a display control server according to an embodiment;

FIG. 2 is a functional block diagram illustrating a configuration of an IoT container according to the embodiment;

FIG. 3 is a functional block diagram illustrating a configuration of the display control server according to the embodiment;

FIG. 4 is a diagram illustrating an example of a data structure of a container management table according to the embodiment;

FIG. 5 is a diagram illustrating an example of a data structure of a customer management table according to the embodiment;

FIG. 6 is a diagram illustrating an example of a data structure of a distribution rule table according to the embodiment;

FIG. 7 is a functional block diagram illustrating a configuration of a first terminal according to the embodiment;

FIG. 8A is a diagram illustrating an example of an image to be displayed on a display unit of an IoT container;

FIG. 8B is a diagram illustrating another example of the image to be displayed on the display unit of the IoT container;

FIG. 8C is a diagram illustrating another example of the image to be displayed on the display unit of the IoT container;

FIG. 8D is a diagram illustrating another example of the image to be displayed on the display unit of the IoT container;

FIG. 8E is a diagram illustrating another example of the image to be displayed on the display unit of the IoT container;

FIG. 8F is a diagram illustrating another example of the image to be displayed on the display unit of the IoT container;

FIG. 9 is a diagram illustrating an example of an edit screen of the first terminal;

FIG. 10 is a diagram illustrating an example of a sequence of display control processing according to the embodiment;

FIG. 11 is a diagram illustrating another example of the sequence of the display control processing according to the embodiment;

FIG. 12 is a diagram illustrating an example of an application of the display control system according to the embodiment; and

FIG. 13 is a diagram illustrating an example of a computer that executes a display control program.

### DESCRIPTION OF EMBODIMENTS

Preferred embodiments will be explained with reference to accompanying drawings. The present invention is not limited to the embodiments.

Configuration of Operation Management Device

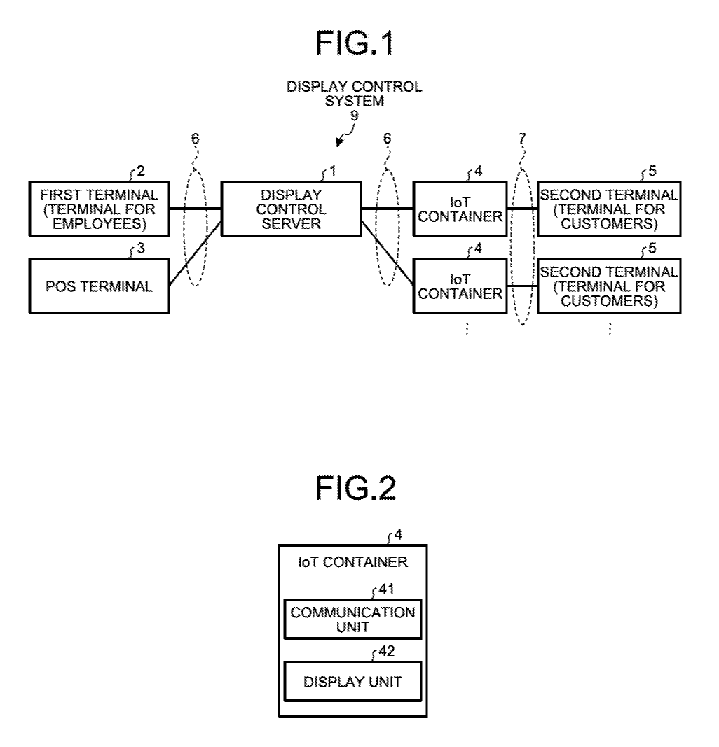

FIG. 1 is a functional block diagram illustrating a configuration of a display control system including a display control server according to an embodiment. A display control server 1 according to the present embodiment receives registration of a target image to be displayed on a display unit of, for example, an IoT (Internet of Things) container, and upon acquisition of identification information of the IoT container or the display unit of the IoT container, transmits the registered image to a destination corresponding to the identification information. The display control server 1 displays the image on the display unit of the IoT container. That is, the display control server 1 automatically displays information such as an image corresponding to a user who uses the IoT container on the display unit of the IoT container. The IoT container referred to herein is a container having a communication function and a display function, and in the present embodiment, a beverage container provided in shops offering food and beverage services.

As illustrated in FIG. 1, a display control system 9 includes the display control server 1, a first terminal 2, a POS (Point Of Sales) terminal 3, IoT containers 4, and second terminals 5.

The display control server 1 is mutually connected to the first terminal 2 and the POS terminal 3 via a network 6 in a communicable manner. The display control server 1 is also mutually connected to the IoT container 4 via the network 6 in a communicable manner. The network 6 referred to herein is a Wi-Fi network, but is not limited thereto, and can be other types of communication networks such as a carrier network. The IoT container 4 is mutually connected to the second terminal 5 via a network 7 in a communicable manner. The network 7 referred to herein is, for example, the Bluetooth such as BLE (Bluetooth® Low Energy). However, the network 7 is not limited thereto, and it suffices that the IoT container 4 and the second terminal 5 are connected to each other in a communicable manner. The configuration of the display control server 1 is described later.

The first terminal 2 is an example of a terminal for employees. The first terminal 2 is a tablet terminal, for example, but is not limited thereto, and can be a terminal such as a portable personal computer. As an example, the first terminal 2 can be other types of terminals, so long as an edit screen of an image to be displayed on the IoT container 4 can be displayed or information of the image to be displayed on the IoT container 4 can be notified to the display control server 1. The configuration of the first terminal 2 is described later.

The POS terminal 3 identifies customer information of a customer who visits the shop and settles a sales transaction of beverages purchased by the customer. For example, the POS terminal 3 reads a prepaid card unique to the shop presented by the customer or a barcode on an application screen unique to the shop displayed on the second terminal 5 as a terminal for customers described later to identify the customer information of the customer. The POS terminal 3 settles the sales transaction of beverages purchased by the customer with respect to the customer information. The POS terminal 3 transmits the customer information of the customer to the display control server 1 to associate the customer with the IoT container 4 as a container of a beverage. The POS terminal 3 stores the settled settlement information in a storage unit (not illustrated). The settlement information includes, for example, customer information of a customer, a product name, a price, and a purchased time.

The IoT container 4 is a container having a communication function, a display function, and a barcode. For example, the IoT container 4 is a container that can display an image transmitted from the display control server 1 on the display unit thereof. The IoT container 4 is a container also having a barcode for distinguishing the IoT container 4 itself from other IoT containers 4. The barcode can be displayed by the display function or can be attached on a side surface of the container. The barcode corresponds to an IoT container ID (IDentifier) described later. The IoT container 4 has been explained as a beverage container including a mug or a tumbler, but is not limited thereto, and can be a food container. Further, the IoT container 4 can be a container having a handle or a container without a handle. The configuration of the IoT container 4 is described later.

The second terminal 5 is an example of a terminal for customers. The second terminal 5 is, for example, a mobile phone such as a smartphone, but is not limited thereto, and can be a terminal such as a PDA (Personal Digital Assistant) or a portable personal computer. As an example, the second terminal 5 can be other types of terminals so long as the terminal can display an application screen unique to a shop, can take in an image displayed on the display unit of the IoT container 4 from an application unique to the shop, or can refer to the image. The application unique to a shop to be installed in the second terminal 5 may be referred to as “mobile application”.

Configuration of the IoT Container

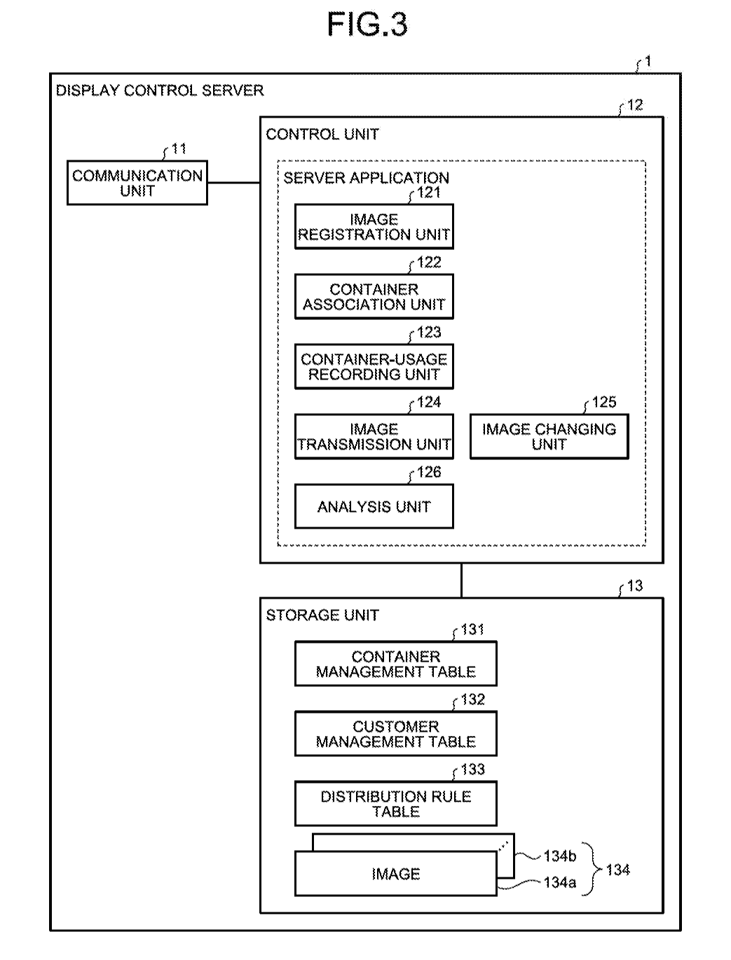

FIG. 2 is a functional block diagram illustrating a configuration of the IoT container according to the present embodiment. As illustrated in FIG. 2, the IoT container 4 includes a communication unit 41 and a display unit 42.

The communication unit 41 performs communication with the display control server 1 via the network 6 (see FIG. 1). The communication unit 41 also performs communication with the second terminal 5 via the network 7 (see FIG. 1). The communication unit 41 is realized by an NIC (Network Interface Card), for example.

The display unit 42 displays an image transmitted from the display control server 1. The display unit 42 is electronic paper, but is not limited thereto, and can be other types of devices so long as it is attached on the IoT container 4 and can display an image.

Configuration of Display Control Server

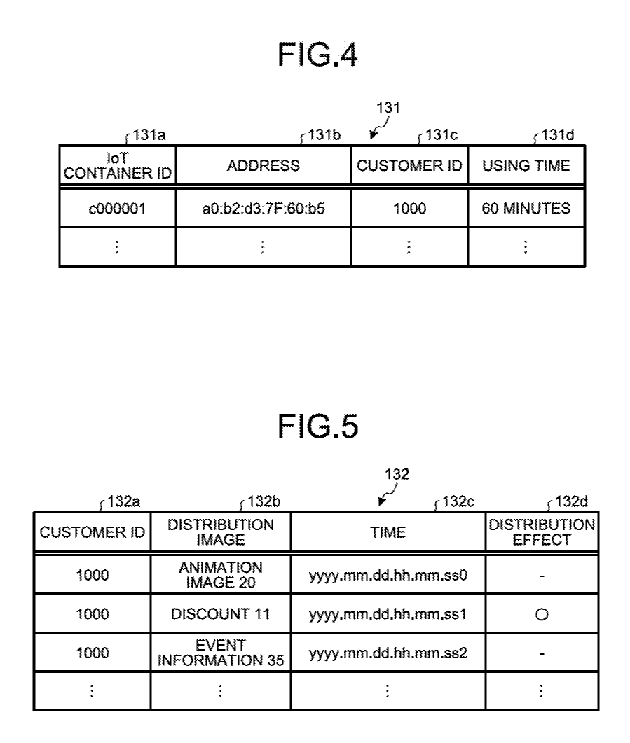

FIG. 3 is a functional block diagram illustrating a configuration of the display control server according to the present embodiment. As illustrated in FIG. 3, the display control server 1 includes a communication unit 11, a control unit 12, and a storage unit 13.

The communication unit 11 performs communication with the first terminal 2, the POS terminal 3, and the IoT container 4 via the network 6 (see FIG. 1). The communication unit 11 is realized by an NIC (Network Interface Card), for example.

The control unit 12 corresponds to an electronic circuit such as a CPU (Central Processing Unit). The control unit 12 includes an internal memory for storing therein a program in which various process procedures are specified and control data, and performs various types of processes using the program and control data. It is assumed here that the control unit 12 performs processing by a server application. The control unit 12 includes an image registration unit 121, a container association unit 122, a container-usage recording unit 123, an image transmission unit 124, an image changing unit 125, and an analysis unit 126. The container association unit 122 is an example of a reception unit. A container management table 131 is an example of a storage unit. The image transmission unit 124 and the image changing unit 125 are examples of a display unit.

The storage unit 13 is, for example, a semiconductor memory element such as a RAM (Random Access Memory) or a flash memory, or a storage device such as a hard disk or an optical disk. The storage unit 13 includes the container management table 131, a customer management table 132, a distribution rule table 133, and images 134.

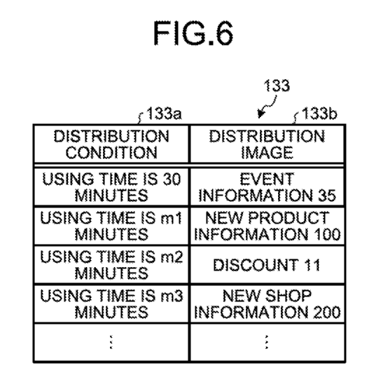

The container management table 131 manages the IoT container 4. A data structure of the container management table 131 is explained here with reference to FIG. 4.

FIG. 4 is a diagram illustrating an example of a data structure of the container management table according to the present embodiment. As illustrated in FIG. 4, the container management table 131 stores therein an IoT container ID 131a, an address 131b, a customer ID 131c, and a using time 131d in association with each other. The IoT container ID 131a indicates identification information of the IoT container 4 or the display unit 42 of the IoT container 4. The address 131b indicates an address of the IoT container 4. The address 131b is, for example, a MAC (Media Access Control) address, but is not limited thereto, and can be any address as far as it indicates a destination of the IoT container 4. The customer ID 131c indicates identification information of a customer. The customer information referred to herein is information indicating a prepaid card unique to a shop or a barcode on the application screen unique to the shop. The using time 131d indicates a time during which a customer uses the IoT container 4.

As an example, when the IoT container ID 131a is “c000001”, “a0:b2:d3:7F:60:b5” is stored as the address 131b and “1000” is stored as the customer ID 131c.

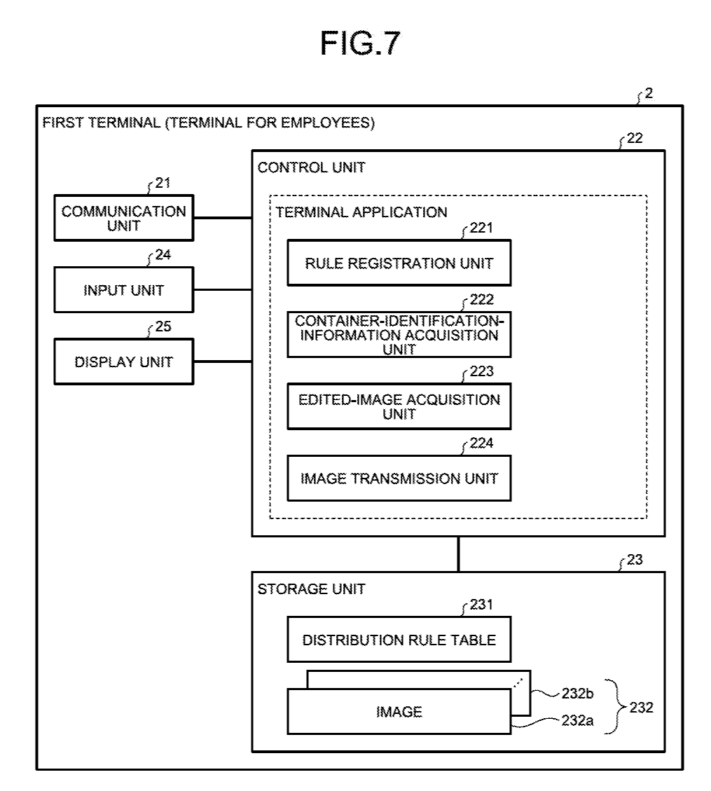

Referring back to FIG. 3, the customer management table 132 manages information of an image distributed to customers. A data structure of the customer management table 132 is explained here with reference to FIG. 5.

FIG. 5 is a diagram illustrating an example of a data structure of the customer management table according to the present embodiment. As illustrated in FIG. 5, the customer management table 132 stores therein a customer ID 132a, a distribution image 132b, a time 132c, and a distribution effect 132d in association with each other. The customer ID 132a indicates customer information of a customer. The customer ID 132a corresponds to the customer ID 131c in the container management table 131. The distribution image 132b indicates information identifying an image distributed to the IoT container 4 associated with the customer. The information identifying an image can include, for example, the name of the image and the number of the image. The time 132c indicates a time when the image indicated by the distribution image 132b has been distributed. The distribution effect 132d indicates information indicating whether the distribution image 132b has an effect of new usage or purchase. When there has been an effect, “◯” is set as an example. As an initial value of the distribution effect 132d, “-” is set as an example.

As an example, when the customer ID 132a is “1000”, “animation image 20” is stored as the distribution image 132b, and “yyyy.mm.dd.hh.mm.ss0” is stored as the time 132c. Further, when the customer ID 132a is “1000”, “discount 11” is stored as the distribution image 32b, “yyyy.mm.dd.hh.mm.ss1” is stored as the time 132c, and “◯” is stored as the distribution effect 132d.

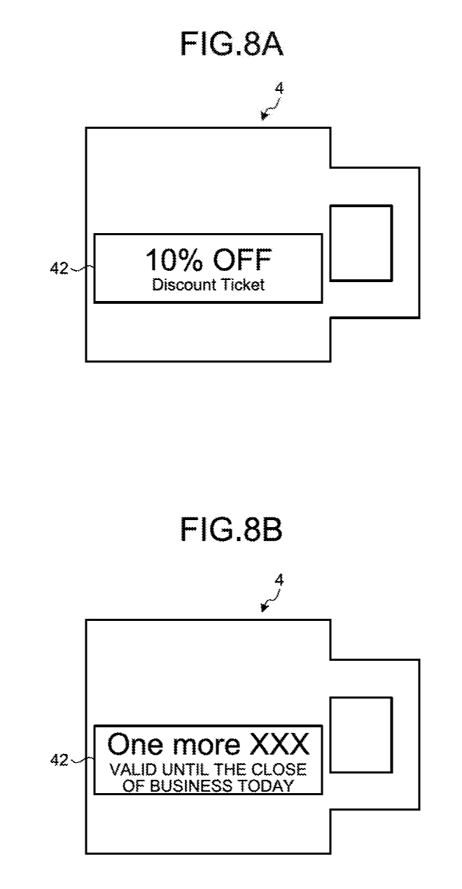

Referring back to FIG. 3, the distribution rule table 133 manages the distribution rule. The distribution rule table 133 can store therein a distribution rule registered by the first terminal 2 or can store therein a distribution rule in advance before system operation. In the present embodiment, a case where the distribution rule table 133 stores therein a distribution rule registered by the first terminal 2 is explained. A data structure of the distribution rule table 133 is explained here with reference to FIG. 6.

FIG. 6 is a diagram illustrating an example of a data structure of the distribution rule table according to the present embodiment. As illustrated in FIG. 6, the distribution rule table 133 stores therein a distribution condition 133a and a distribution image 133b in association with each other. The distribution condition 133a indicates a condition to distribute an image. The distribution condition 133a is a condition, for example, using a using time when a customer has used the shop, but is not limited thereto, and can be a condition using a specific time or other conditions. The distribution image 133b indicates information identifying an image to be distributed when the distribution condition 133a is matched. The distribution image 133b corresponds to the distribution image 132b in the customer management table 132.

As an example, when the distribution condition 133a is “using time is 30 minutes”, “event information 35” is stored as the distribution image 133b, and when the distribution condition 133a is “using time is m2 minutes”, “discount 11” is stored in the distribution rule table 133.

Referring back to FIG. 3, the images 134 are images to be distributed. In the following descriptions, in order to distinguish a plurality of images 134, these images are described as “image 134a” and “image 134b”. In the case where these images 134 are explained without distinguishing them, these images are collectively described as “image 134”. The image 134 includes, for example, an image 134a in which an illustration is drawn, and an image 134b in which a message is written. In the image 134a in which an illustration is drawn, for example, an animation image is included. In the image 134b in which a message is written, for example, discount information, new product information, event information, and new shop information are included. The image 134 is created and edited by using an edit screen of the first terminal 2 and registered in the storage unit 13. The image 134 includes not only images but also letters.

The image registration unit 121 registers the image 134 in the storage unit 13. For example, upon reception of the image 134 created on the edit screen of the first terminal 2 before system operation, the image registration unit 121 adds the image 134 in the storage unit 13. Further, upon reception of the image 134 edited on the edit screen of the first terminal 2, the image registration unit 121 adds the image 134 in the storage unit 13 or changes the image 134.

The container association unit 122 associates the IoT container 4 with a customer, when usage of the IoT container 4 is started or purchase is complete.

For example, when identification information of the IoT container 4 is acquired from the first terminal 2, the container association unit 122 performs the following processes. When the acquired identification information is not stored in the IoT container ID 131a in the container management table 131, the container association unit 122 decides that it is a timing at which usage of the container indicated by the IoT container 4 is started. The container association unit 122 stores the identification information acquired as the IoT container ID 131a, an address corresponding to the identification information as the address 131b, and “0” as the using time 131d in association with each other in the container management table 131. The address corresponding to the identification information only needs to be held in an address table in advance.

Upon acquisition of customer information of a customer from the POS terminal 3, the container association unit 122 stores the customer information in the customer ID 131c corresponding to the IoT container ID 131a actually stored in the container management table 131. Accordingly, the container association unit 122 can associate the IoT container 4 with the customer. The timing of acquiring the customer information of the customer can be either at a timing at which usage of the IoT container 4 is started or a timing at which purchase is complete.

The container-usage recording unit 123 records an elapsed time since the timing at which usage of the IoT container 4 is started. For example, the container-usage recording unit 123 activates a timer from the timing at which usage of the IoT container 4 is started. The container-usage recording unit 123 then updates the using time 131d corresponding to the IoT container ID 131a in the container management table 131.

The image transmission unit 124 transmits an image of individual IoT container 4 with respect to respective IoT containers 4.

For example, upon acquisition of the identification information of the IoT container 4 and the image number of the distribution image from the first terminal 2, the image transmission unit 124 transmits the image corresponding to the acquired image number in the image 134 registered in the storage unit 13 to a destination IoT container 4. Accordingly, the image transmission unit 124 can cause the IoT container 4 to display an individual image.

Further, upon acquisition of the identification information of the IoT container 4, the image transmission unit 124 can cause the first terminal 2 to display the edit screen on which an image to be displayed on the display unit of the IoT container 4 is input. Upon acquisition of the identification information of the IoT container 4 and the input distribution image from the first terminal 2, the image transmission unit 124 transmits the acquired distribution image to the destination IoT container 4 associated with the identification information. Accordingly, by causing the first terminal 2 to display the edit screen in response to the acquisition of the identification information of the IoT container 4, the image transmission unit 124 can cause an employee to perform editing of the target image to be displayed on the IoT container 4 efficiently.

Further, upon acquisition of the identification information of the IoT container 4 and the information of the beverage to be provided in the IoT container 4, the image transmission unit 124 can cause the first terminal 2 to display the edit screen on which the information of the beverage and an image to be displayed on the display unit of the IoT container 4 are input. When the identification information of the IoT container 4 and the input distribution image are acquired from the first terminal 2, the image transmission unit 124 transmits the acquired distribution image to the destination IoT container 4 associated with the identification information. Accordingly, the image transmission unit 124 can cause an employee to confirm the type of the beverage to be provided in the IoT container 4 and to perform input of a target image to be displayed on the IoT container 4 efficiently.

Upon acquisition of the identification information of the IoT container 4 and the information of the beverage to be provided in the IoT container 4, the image transmission unit 124 can transmit an image corresponding to the information of the beverage in the image 134 registered in the storage unit 13 to the destination IoT container 4 associated with the identification information. Accordingly, as the image transmission unit 124 causes the IoT container 4 to display the beverage ordered by a customer, the customer can confirm the type of the beverage ordered by the customer himself.

The image transmission unit 124 acquires the customer ID 131c of a customer associated with the identification information of the IoT container 4 from the container management table 131. The image transmission unit 124 stores the information of the transmitted image in the customer management table 132 in association with the acquired customer ID 131c.

The image changing unit 125 changes an image to be displayed on the IoT container 4 according to a predetermined condition. For example, the image changing unit 125 changes the image to be displayed on the IoT container 4 according to an elapsed time since a timing at which usage of the IoT container 4 is started. As an example, the image changing unit 125 refers to the distribution rule table 133 to determine whether the using time 131d corresponding to the IoT container 4 in the container management table 131 matches the distribution condition 133a. If the using time 131d matches the distribution condition 133a, the image changing unit 125 transmits the distribution image 133b corresponding to the matched distribution condition 133a to the destination IoT container 4 associated with the IoT container 4 corresponding to the using time 131d. Accordingly, the image changing unit 125 can change an image to be presented on the IoT container 4 according to the elapsed time.

The image changing unit 125 also acquires the customer ID 131c of the customer associated with the identification information of the IoT container 4 from the container management table 131. The image transmission unit 124 adds the information of the changed image in the customer management table 132 in association with the acquired customer ID 131c.

The analysis unit 126 uses the image displayed on the IoT container 4 to analyze whether new usage or purchase has been made. For example, the analysis unit 126 analyzes whether there has been an effect of new usage or purchase in a distribution image based on the settlement information accumulated in the POS terminal 3 and the information accumulated in the customer management table 132.

As an example, there is assumed a case where the second terminal 5 can take in or refer to an image to be displayed on the display unit 42 of the IoT container 4 from a mobile application. In such a case, upon acquisition of the customer information of the customer and the image information of the distribution image referred to by the mobile application from the POS terminal 3, the analysis unit 126 determines whether the acquired image information has been set in the distribution image corresponding to the customer information in the customer management table 132. If the acquired image information has been set in the distribution image corresponding to the customer information in the customer management table 132, the analysis unit 126 can analyze that there has been an effect of new usage or purchase in the distribution image. The analysis unit 126 then sets “◯” indicating that there has been an effect in the distribution effect 132d corresponding to the distribution image in the customer management table 132. As an analysis result setting “◯” by the analysis unit 126, such a case where a customer newly purchases a beverage or newly uses the shop is assumed.

As another example, the analysis unit 126 can decide an analysis result based on, after the time 132c when the distribution image 132b has been distributed to a certain customer, whether there is a purchase history in the settlement information of the same customer. Specifically, the image changing unit 125 transmits an image of discount information of “another cup of coffee is 100 Yen” to the IoT container 4 of a customer who stays in the shop for a long time, based on the distribution rule table 133. The customer management table 132 stores therein the transmitted time 132c and the image information of the transmitted discount information in association with the customer. If such a history is recorded in the settlement information that the same customer has purchased coffee at 100 Yen after the time 132c, the analysis unit 126 can analyze that there has been an effect of new usage or purchase in the distribution image. The analysis by the analysis unit 126 can be performed with real-time processing or batch processing. Accordingly, the analysis unit 126 can analyze certain effects of the distribution image.

Configuration of First Terminal

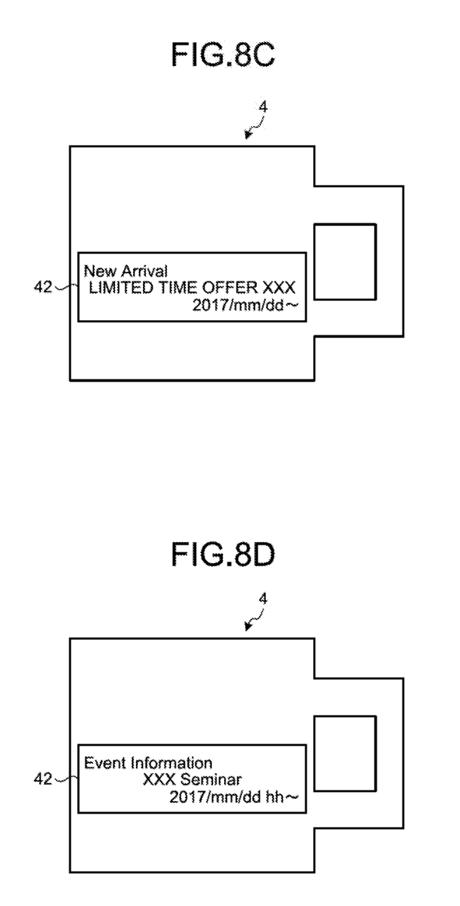

FIG. 7 is a functional block diagram illustrating a configuration of the first terminal according to the present embodiment. As illustrated in FIG. 7, the first terminal 2 includes a communication unit 21, a control unit 22, a storage unit 23, an input unit 24, and a display unit 25.

The communication unit 21 performs communication with the display control server 1 via the network 6 (see FIG. 1). The communication unit 21 is realized by an NIC (Network Interface Card), for example.

For example, the input unit 24 receives various types of input operations from an employee who uses the first terminal 2. For example, the input unit 24 receives a scanning operation of a barcode attached on the IoT container 4. The input unit 24 receives a selecting operation of an image to be displayed on the display unit 42 of the IoT container 4 indicating specific identification information. The input unit 24 receives an editing operation of an image to be displayed on the display unit 42 of the IoT container 4 indicating specific identification information. As the input unit 24, for example, a keyboard, a mouse, or a touch panel can be used.

The display unit 25 displays various types of information. For example, the display unit 25 displays an edit screen of an image to be displayed on the display unit 42 of the IoT container 4 indicating specific identification information based on a request from the display control server 1. The display unit 25 displays a selected image based on a selecting operation from the input unit 24. The display unit 25 displays an edited image based on an editing operation from the input unit 24. As the display unit 25, as an example, a display that displays various types of information can be used. The edit screen referred to herein is a screen for inputting an image to be displayed on the display unit 42 of the IoT container 4 and includes an editing target area in which a predetermined area of an image can be edited. An example of a screen configuration of the edit screen is described later.

The control unit 22 corresponds to electronic circuits such as a CPU (Central Processing Unit). The control unit 22 includes an internal memory for storing therein a program in which various process procedures are specified and control data, and performs various types of processes using the program and control data. It is assumed here that the control unit 22 performs processing by a terminal application corresponding to a server application. The control unit 22 includes a rule registration unit 221, a container-identification-information acquisition unit 222, an edited-image acquisition unit 223, and an image transmission unit 224.

The storage unit 23 is, for example, a semiconductor memory element such as a RAM (Random Access Memory) or a flash memory, or a storage device such as a hard disk or an optical disk. The storage unit 23 includes a distribution rule table 231 and images 232.

The distribution rule table 231 stores a distribution rule therein. The distribution rule table 231 is identical to the distribution rule table 133 of the display control server 1, and thus descriptions thereof are omitted.

The images 232 are images to be displayed on the display unit of the IoT container 4. In the following descriptions, in order to distinguish a plurality of images 232, these images are described as “image 232a” and “image 232b”. In the case where these images 232 are explained without distinguishing them, these images are collectively described as “image 232”. The image 232 is identical to the image 134 of the display control server 1, and thus descriptions thereof are omitted.

The rule registration unit 221 registers a distribution rule. For example, the rule registration unit 221 registers a distribution condition and a distribution image input by an employee in the distribution rule table 231 in association with each other. The rule registration unit 221 transmits the distribution rule table 231 to the display control server 1 so as to be stored in the display control server 1.

The container-identification-information acquisition unit 222 acquires identification information of the IoT container 4. For example, the container-identification-information acquisition unit 222 acquires a barcode indicating the identification information of the IoT container 4 as the identification information from the input unit 24. The container-identification-information acquisition unit 222 transmits the acquired identification information to the display control server 1.

The edited-image acquisition unit 223 acquires an image input by using an edit screen. For example, the edited-image acquisition unit 223 acquires an image or an image number of the image input by using the edit screen, with regard to an image to be displayed on the display unit 42 of the IoT container 4 corresponding to the identification information. Accordingly, an employee who uses the first terminal 2 can input or edit the image to be displayed on the display unit 42 of the IoT container 4 corresponding to the individual information of a customer or the customer's status in the shop associated with the IoT container 4. As the individual information of the customer, as an example, the age or personality of the customer can be mentioned. As the customer's status in the shop, as an example, a using time when the customer uses the shop can be mentioned.

The image transmission unit 224 transmits the information of the image to the display control server 1. For example, the image transmission unit 224 transmits the image or the image number of the image acquired by the edited-image acquisition unit 223 to the display control server 1 along with the identification information of the IoT container 4.

Image to be Displayed on Display Unit of IoT Container

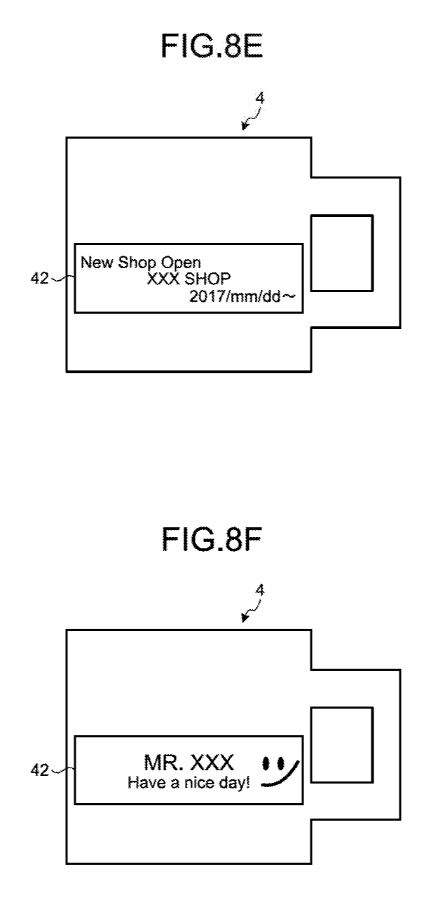

Next, an image example to be displayed on the display unit 42 of the IoT container 4 is explained with reference to FIG. 8A to FIG. 8F. FIG. 8A is a diagram illustrating an example of an image to be displayed on a display unit of an IoT container. As illustrated in FIG. 8A, an image indicating discount information is displayed on the IoT container 4. As the discount information, “10% OFF” is displayed here. For example, the image changing unit 125 causes the display unit 42 of the IoT container 4 to display a distribution image indicating the discount information based on the distribution rule table 133, when the using time corresponding to the IoT container ID of the IoT container 4 has passed a predetermined time.

FIG. 8B to FIG. 8F are diagrams illustrating other examples of the image to be displayed on the display unit of the IoT container. As illustrated in FIG. 8B, an image indicating an advertisement is displayed on the IoT container 4. Here, “One more XXX, valid until the close of business today” is displayed as the information indicating the advertisement.

As illustrated in FIG. 8C, an image indicating an advertisement is displayed on the IoT container 4. Here, “New Arrival Limited time offer xxx 2017/mm/dd˜” is displayed as an image indicating the advertisement.

As illustrated in FIG. 8D, an image indicating event information is displayed on the IoT container 4. Here, “Event Information XXX Seminar 2017/mm/dd hh˜” is displayed as the event information.

As illustrated in FIG. 8E, an image indicating information of a new shop is displayed on the IoT container 4. Here, “New Shop Open XXX shop 2017/mm/dd˜” is displayed as the information of a new shop.

As illustrated in FIG. 8F, an image indicating individual information of other IoT containers 4 is displayed on the IoT container 4. Here, “Mr. XXX, Have a nice day!” is displayed as the individual information of the IoT container 4.

Edit Screen to be Displayed on Display Unit of First Terminal

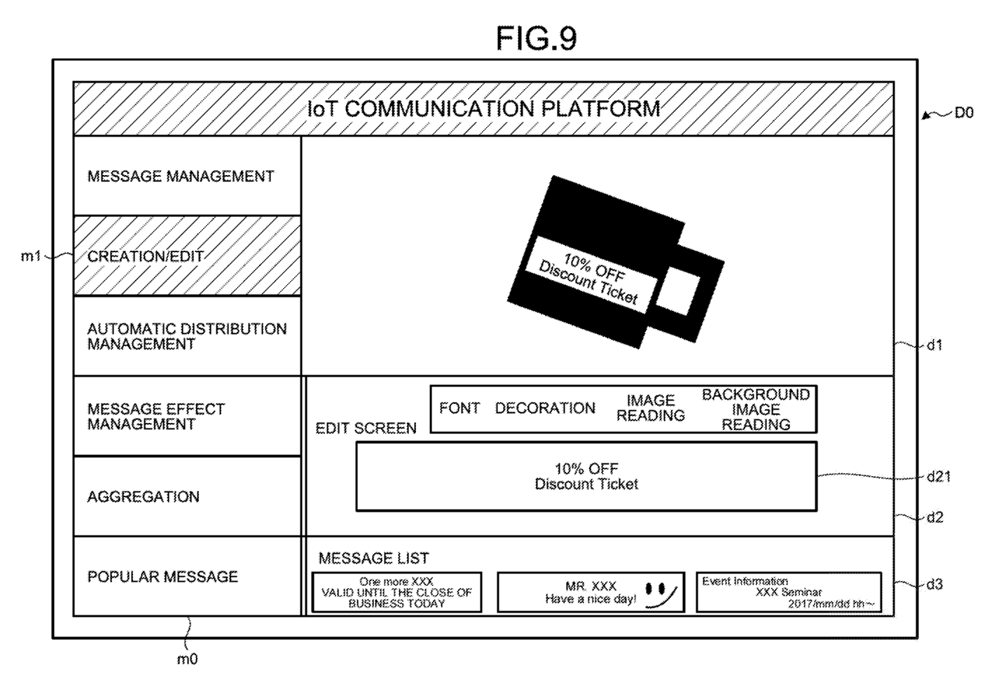

An edit screen example to be displayed on the display unit 25 of the first terminal 2 is explained next with reference to FIG. 9. FIG. 9 is a diagram illustrating an example of an edit screen of the first terminal. As illustrated in FIG. 9, as an example of a screen including a display screen, an IoT communication platform screen D0 is illustrated. The IoT communication platform screen D0 includes a menu screen m0. When, a creation/edit button m1 in the menu screen m0 is selected, a screen d1 for displaying an image diagram of the lot container 4, an edit screen d2, and a message list screen d3 are displayed. The edit screen d2 includes an editing target area d21 in which a predetermined area of an image to be displayed on the display unit 42 of the IoT container 4 can be edited. For example, an employee can edit an image to be displayed on the display unit 42 of a specific IoT container 4 in the editing target area d21 on the edit screen d2, while appropriately referring to the message list d3. The employee can confirm the image to be displayed on the IoT container 4 on the screen d1 each time editing is performed.

Sequence of Display Control Processing

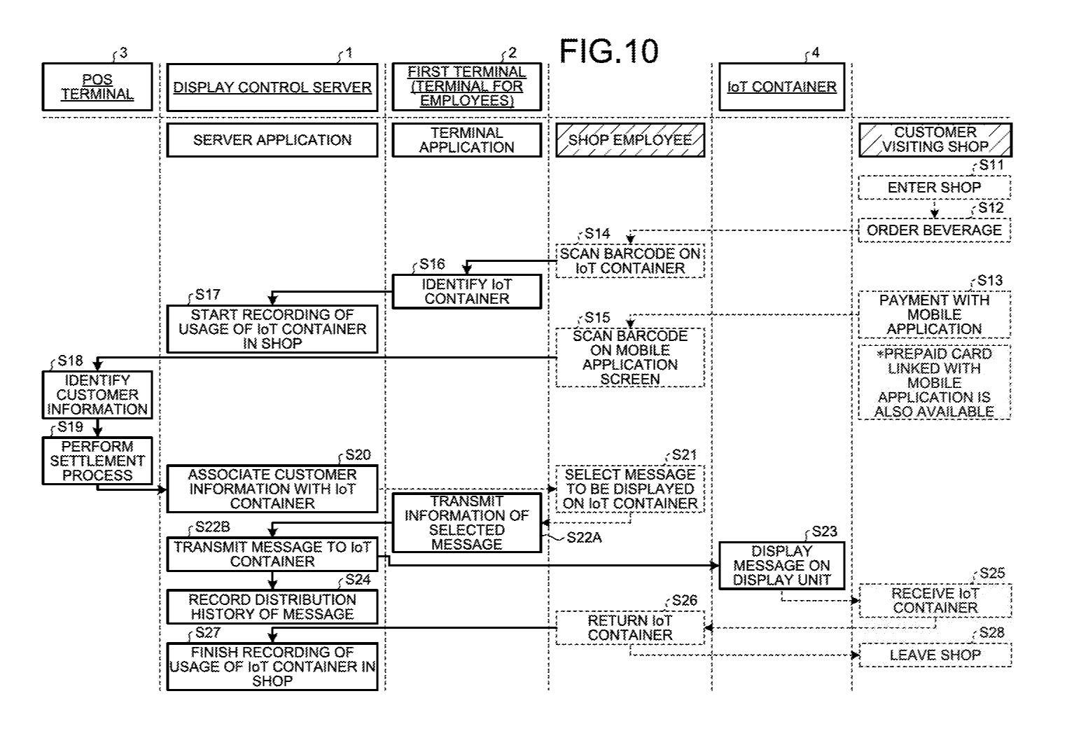

FIG. 10 is a diagram illustrating an example of a sequence of the display control processing according to the present embodiment. In FIG. 10, there is explained a case where when a customer orders a beverage, an employee selects an individual image for each customer and the display control server 1 causes the IoT container 4 corresponding to the customer to display the selected image. A broken line in FIG. 10 indicates processing performed by human.

As illustrated in FIG. 10, a customer enters a shop and orders a beverage (S1, S12). The customer then makes payment with a mobile application installed in the second terminal 5 held by the customer (S13). Instead of the mobile application, the payment can be made by a prepaid card linked with the mobile application.

An employee of the shop having received the beverage order scans a barcode attached on the IoT container 4 (S14). The barcode read from the IoT container 4 is the identification information of the IoT container 4. The employee also scans a barcode on a mobile application screen (S15). The barcode read from the mobile application screen is the customer information of the customer.

The first terminal 2 having received a reading operation of the barcode attached on the IoT container 4 acquires the barcode to identify the IoT container 4 (S16). The first terminal 2 then transmits the acquired barcode to the display control server 1.

The display control server 1 having received the barcode starts recording of usage in the shop of the IoT container 4 corresponding to the barcode (S17). That is, the display control server 1 records an elapsed time since a timing at which usage of the IoT container 4 is started. For example, the display control server 1 determines that it is a timing of start of usage of the IoT container 4, because the barcode is not stored in the IoT container ID 131a in the container management table 131. The display control server 1 stores the barcode, an address corresponding to the barcode, and “0” as a using time in the container management table 131 in association with each other. The display control server 1 activates a timer corresponding to the barcode to record the elapsed time since the timing of start of usage of the IoT container 4.

Meanwhile, the POS terminal 3 having received a scanning operation of the barcode on the mobile application screen acquires the barcode to identify the customer information indicating the customer (S18). The POS terminal 3 then performs a settlement process (S19). The POS terminal 3 then transmits the acquired customer information to the display control server 1.

The display control server 1 having received the customer information associates the customer information with the IoT container 4 of which usage has been started (S20). For example, the display control server 1 stores the customer information in the customer ID 131c corresponding to the IoT container ID 131a in the container management table 131.

The employee of the shop selects a message to be displayed on the display unit 42 of the IoT container 4 associated with the customer (S21). For example, selection of the message is made by using an edit screen.

The first terminal 2 having received the information of the message transmits information of the message and the identification information of the IoT container 4 to the display control server 1 (S22A), and the display control server 1 transmits the message to the IoT container 4 at an address associated with the identification information (S22B). The information of the message can be the message itself or the message number. The message can be also an image or letters.

The IoT container 4 having received the message displays the message on the display unit 42 (S23). Meanwhile, the display control server 1 having transmitted the message records the information of the message transmitted to the IoT container 4 in the customer management table 132 as a distribution history (S24). For example, the display control server 1 acquires customer information of a customer associated with the identification information of the IoT container 4 from the container management table 131. The display control server 1 then adds the transmitted information of the message to the customer management table 132 in association with the acquired customer information.

Subsequently, the customer receives the IoT container 4 (S25).

Thereafter, an employee of the shop returns the IoT container 4 (S26).

The display control server 1 having received the return of the IoT container 4 finishes recording of usage of the returned IoT container 4 in the shop (S27). For example, the display control server 1 stops the timer corresponding to the identification information of the IoT container 4 to finish recording of the elapsed time. Meanwhile, the customer who has returned the IoT container 4 leaves the shop (S28).

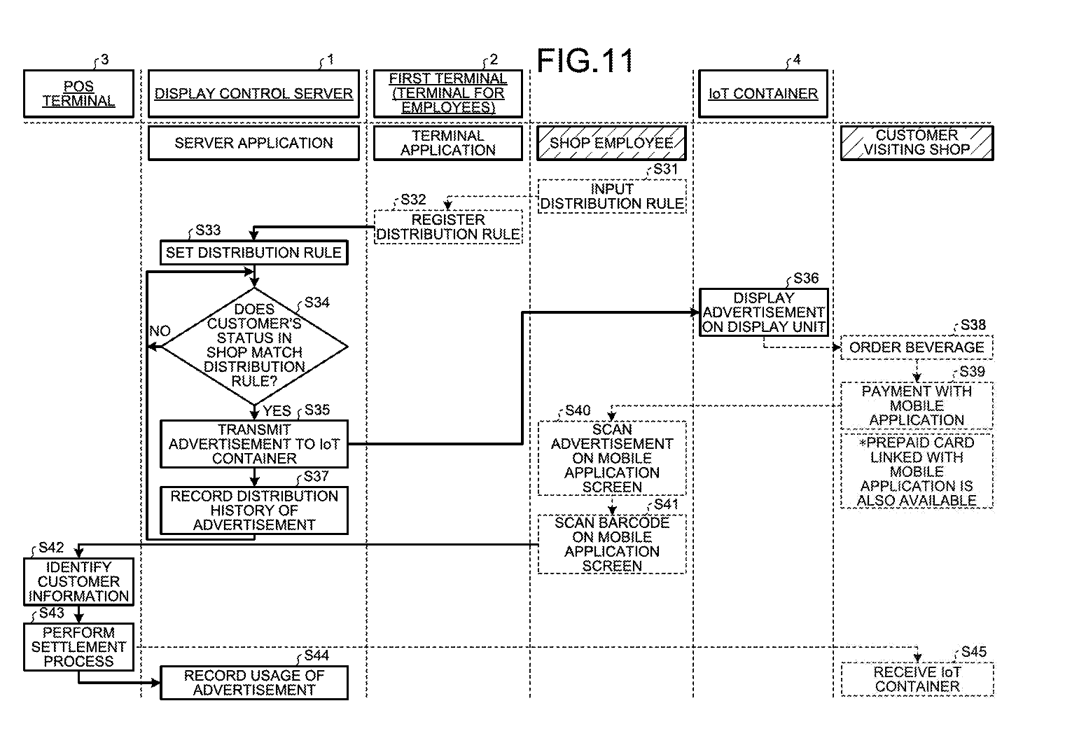

FIG. 11 is a diagram illustrating another example of the sequence of the display control processing according to the present embodiment. In FIG. 11, there is explained a case where when the customer's status in a shop matches a distribution rule, the display control server 1 identifies an image of advertisement corresponding to the matched distribution rule and displays the identified image on the IoT container 4 corresponding to the customer. A broken line in FIG. 11 indicates processing performed by human.

As illustrated in FIG. 11, the first terminal 2 having received the distribution rule input by an employee of the shop registers the received distribution rule in the distribution rule table 231 (S31, S32). For example, the first terminal 2 registers the distribution rule associated with a distribution condition and a distribution image of advertisement in the distribution rule table 231 (S32). The first terminal 2 transmits the registered distribution rule to the display control server 1.

The display control server 1 having received the distribution rule sets the received distribution rule in the distribution rule table 133 in the storage unit 13 (S33). Thereafter, the display control server 1 refers to the distribution rule table 133 to determine whether the customer's status in the shop matches the distribution rule (S34). For example, the display control server 1 refers to the distribution rule table 133 to determine whether the using time 131d corresponding to the IoT container 4 in the container management table 131 matches the distribution condition 133a.

When the display control server 1 has determined that the customer's status in the shop does not match the distribution rule (NO at S34), the display control server 1 shifts the processing to S34. On the other hand, when the display control server 1 has determined that the customer's status in the shop matches the distribution rule (YES at S34), the display control server 1 transmits an advertisement indicating the distribution image corresponding to the matched distribution rule to the IoT container 4 at the address 131b corresponding to the using time 131d (S35).

The IoT container 4 having received the message displays the advertisement on the display unit 42 (S36). Meanwhile, the display control server 1 having transmitted the message records the advertisement information transmitted to the IoT container 4 in the customer management table 132 as a history (S37). For example, the display control server 1 acquires the customer information of the customer associated with the identification information of the IoT container 4 from the container management table 131. The display control server 1 then adds the transmitted advertisement information in the customer management table 132 in association with the customer information.

Thereafter, it is assumed that the customer has ordered a beverage (S38). The customer then makes payment with a mobile application installed in the second terminal 5 held by the customer (S39). Instead of the mobile application, the payment can be made by a prepaid card linked with the mobile application.

An employee of the shop having received the order of the beverage scans the advertisement on the mobile application screen (S40). It is assumed that the advertisement read from the mobile application screen is information obtained by taking in or referring to the advertisement displayed on the IoT container 4. The employee also scans the barcode on the mobile application screen (S41). The barcode read from the mobile application screen is the customer information of the customer.

The POS terminal 3 having received a scanning operation of the barcode or a scanning operation of the advertisement on the mobile application screen acquires the barcode to identify the customer information indicating the customer (S42). The POS terminal 3 then performs a settlement process (S43). The POS terminal 3 then transmits the acquired customer information and advertisement information to the display control server 1.

The display control server 1 having received the customer information and the advertisement information records usage of the advertisement (S44). For example, if the received advertisement information has been set in the distribution image corresponding to the customer information in the customer management table 132, the display control server 1 sets “◯” indicating that there has been an effect in the distribution effect 132d corresponding to the distribution image.

Meanwhile, when the settlement process is complete, the customer receives the IoT container 4 (S45). Thereafter, in the display control processing, the processes at S33 to S45 are repeated until the customer leaves the shop.

Application of Display Control System

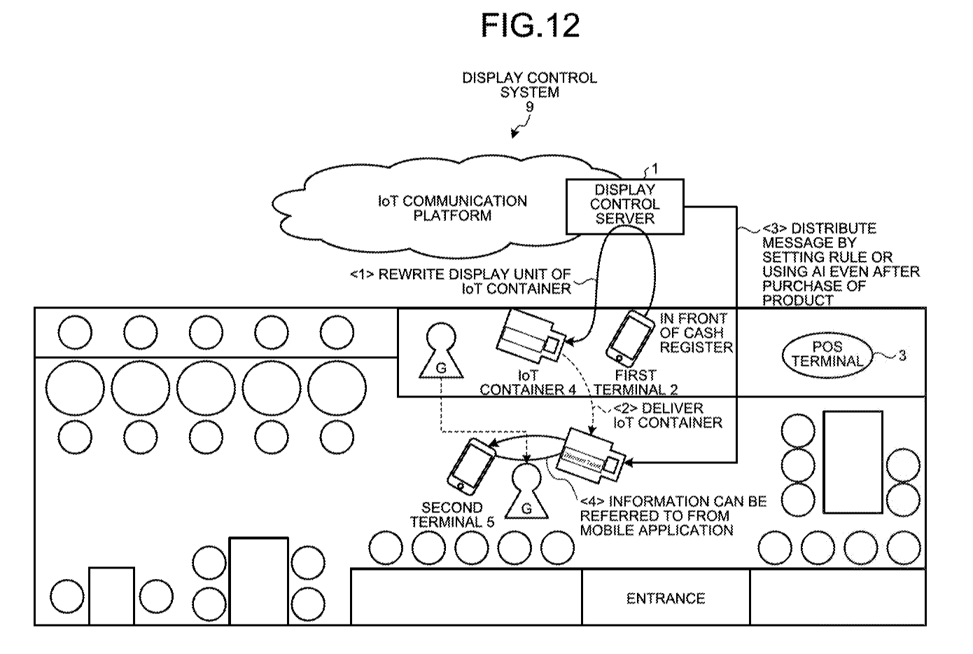

FIG. 12 is a diagram illustrating an example of an application of the display control system according to the present embodiment. FIG. 12 is an example of an eating establishment. The display control server 1 is connected with the IoT container 4, the first terminal 2 placed in front of a cash register, and the POS terminal 3 via Wi-Fi, respectively. The IoT container 4 is connected with the second terminal 5 via the BLE. In FIG. 12, explanations are made while focusing on a customer G among a plurality of customers.

As illustrated in FIG. 12, when the customer G orders a beverage, an employee scans the barcode of the IoT container 4, into which the beverage is filled, by using the first terminal 2 and scans the barcode on the mobile application screen of the second terminal 5 of the customer by using the POS terminal 3. The display control server 1 having received the barcode (identification information) of the IoT container 4 and the barcode (customer information) on the mobile application screen associates the IoT container 4 with the customer. <1> An employee rewrites the display unit 42 of the target IoT container 4 via Wi-Fi by using the terminal application of the first terminal 2, for example, based on the customer information such as the age or personality of the customer G. <2> The employee delivers the IoT container 4 in which the ordered beverage is filled. <3> Thereafter, the display control server 1 distributes a message to the target IoT container 4 via Wi-Fi to display the message on the display unit 42 of the target IoT container 4, for example, by using the set distribution rule or AI (Artificial Intelligence). <4> The customer G can refer to the information displayed on the display unit 42 from the mobile application of the second terminal 5.

Accordingly, the display control system 9 can display an appropriate message on the IoT container 4 associated with the customer, according to the customer information of the customer or the customer's status in the shop.

In the present embodiment, it has been explained that, after acquiring the identification information of the IoT container 4 from the first terminal 2, the container association unit 122 acquires the customer information of the customer from the POS terminal 3 and associates the acquired identification information with the customer information. However, the operation of the container association unit 122 is not limited thereto, and the container association unit 122 can first acquire the customer information of the customer from the POS terminal 3, then acquire the identification information of the IoT container 4 from the first terminal 2 and associate the acquired identification information with the customer information. In this case, upon acquisition of the customer information of the customer from the POS terminal 3, the container association unit 122 stores the customer information as the customer ID 131c and “0” as the using time 131d in the container management table 131 in association with each other. Subsequently, upon acquisition of the identification information of the IoT container 4 from the first terminal 2, the container association unit 122 can store the identification information in the IoT container ID 131a corresponding to the customer ID 131c, which has been actually stored in the container management table 131.

In the present embodiment, it has been explained that the image changing unit 125 changes an image to be displayed on the IoT container 4 according to the elapsed time since the timing of start of usage of the IoT container 4. However, the operation of the image changing unit 125 is not limited thereto, and the image changing unit 125 can change the image to be displayed on the IoT container 4 according to the information from a sensor attached on the IoT container 4. The sensor referred to herein can include, for example, a temperature sensor and a pressure sensor.

For example, it is assumed that the sensor is a temperature sensor. In this case, the display control server 1 acquires the temperature of the IoT container 4 from the temperature sensor attached on the IoT container 4 currently being used, at a regular predetermined time interval. The image changing unit 125 refers to the container management table 131, and if the acquired temperature matches the preset distribution condition, the image changing unit 125 only needs to transmit the distribution image corresponding to the matched distribution condition to the IoT container 4 corresponding to the acquired temperature. In the distribution rule table 133, as an example, it suffices that “Temperature is 100° C.” as the distribution condition 133a and “It is Hot, be careful” as the distribution image 133b are stored. As another example, it suffices that “Temperature is 80° C. to 90° C.” as the distribution condition 133a and “Ready for drinking!” as the distribution image 133b are stored.

Effects of the Embodiment

As described above, the display control server 1 receives registration of a target image to be displayed on the display unit 42 of the IoT container 4. Upon acquisition of the identification information of the IoT container 4 or the display unit 42 of the IoT container 4, the display control server 1 transmits the registered image to a destination associated with the identification information and displays the image on the display unit 42 of the IoT container 4. According to this configuration, the display control server 1 can transmit individual information for each IoT container 4. In other words, the display control server 1 can display individual information unique to each IoT container 4 on the display unit 42 of the IoT container 4.

The display control server 1 also displays letters or figures on the display unit 42 of the IoT container 4. According to this configuration, the display control server 1 can display individual letters or figures unique to each IoT container 4 on the display unit 42 of the IoT container 4.

Upon acquisition of the identification information of the IoT container 4 or the display unit 42 of the IoT container 4, the display control server 1 causes the first terminal 2 to display the acquired identification information and an edit screen of an image to be displayed on the display unit 42 of the IoT container 4. The display control server 1 transmits an image input on the edit screen of the first terminal 2 to a destination associated with the identification information of the IoT container 4 or the display unit 42 of the IoT container 4 to display the image on the display unit 42 of the IoT container 4. According to this configuration, in response to the acquisition of the identification information of the IoT container 4 or the display unit 42 of the IoT container 4, the display control server 1 automatically displays the edit screen for a target image to be displayed on the display unit 42, thereby enabling to perform editing of the image to be displayed on the display unit 42 efficiently.

Upon acquisition of the identification information of the IoT container 4 or the display unit 42 of the IoT container 4 and the information of the beverage to be provided in the IoT container 4, the display control server 1 causes the first terminal 2 to display the information of the beverage and the edit screen of the image to be displayed on the display unit 42 of the IoT container 4. The display control server 1 transmits the image input on the edit screen of the first terminal 2 to the destination associated with the identification information of the IoT container 4 or the display unit 42 of the IoT container 4, in order to display the image on the display unit 42 of the IoT container 4. According to this configuration, the display control server 1 can cause an employee to confirm the type of the beverage provided in the IoT container 4 and input letters or a message to be displayed on the display unit 42 of the IoT container 4.

The display control server 1 also causes the first terminal 2 to display the edit screen including the editing target area in which a predetermined area of the image to be displayed on the IoT container 4 can be edited. According to this configuration, the display control server 1 can allow an employee to freely input letters or a message to be displayed on the display unit 42 of the IoT container 4.

Upon acquisition of the identification information of the IoT container 4 or the display unit 42 of the IoT container 4 and the information of the beverage to be provided in the IoT container 4, the display control server 1 performs the following processes. The display control server 1 transmits the letters or the image corresponding to the information of the beverage to a destination associated with the identification information of the IoT container 4 or the display unit 42 of the IoT container 4 to display the letters or the image corresponding to the information of the beverage on the display unit 42 of the IoT container 4. According to this configuration, the display control server 1 can cause a user to confirm the type of the beverage ordered by the user by displaying what is ordered by the user on the display unit 42 of the IoT container 4.

When usage of a specific object that can display data is started or purchase thereof is complete, the display control server 1 acquires information of the user or a purchaser of the object. The display control server 1 stores acquired information of the user or the purchaser in the container management table 131 in association with the identification information of the object. The display control server 1 displays data corresponding to the stored information of the user or the purchaser on the object. According to this configuration, the display control server 1 can send data according to the corresponding user or the corresponding purchaser to each object.

The display control server 1 changes data to be displayed on the object according to the elapsed time since a timing of start of usage of a specific object or a timing of purchase thereof. According to this configuration, the display control server 1 can present data corresponding to the elapsed time to the specific object.

Further, the display control server 1 changes data to be displayed on the object according to the information from the sensor attached on a specific object. According to this configuration, the display control server 1 can present data corresponding to the information from the sensor attached on the specific object to the specific object.

The information of the user or the purchaser includes information of the object that has been used at the time of usage or purchase in the past by the user or the purchaser. According to this configuration, the display control server 1 can send data according to the information of the object that has been used at the time of usage or purchase in the past by the user or the purchaser.

The display control server 1 also determines and outputs whether new usage or purchase has been made using the data displayed on the object. According to this configuration, the display control server 1 can present the effects of data displayed on the object.

Other Features

The display control server 1 can be realized by incorporating various functions of the control unit 12, the storage unit 13, and the like described above in a known information processing unit such as a personal computer or a workstation.

In the above embodiment, it is not always needed that the respective constituent elements of the devices illustrated in the drawings are physically configured as illustrated in the drawings. That is, specific modes of separation and integration of the devices are not limited to those illustrated in the drawings, and it is possible to configure that a part or all of these elements are functionally or physically separated or integrated in an arbitrary unit, according to various types of loads and use status. For example, the image transmission unit 124 and the image changing unit 125 can be integrated with each other. The image transmission unit 124 can be separated into a functional unit that causes an edit screen to be displayed on the first terminal 2 and a functional unit that causes a predetermined image to be displayed on the IoT container 4. It is also possible that the storage unit 13 is connected as an external device of the display control server 1 via a network.

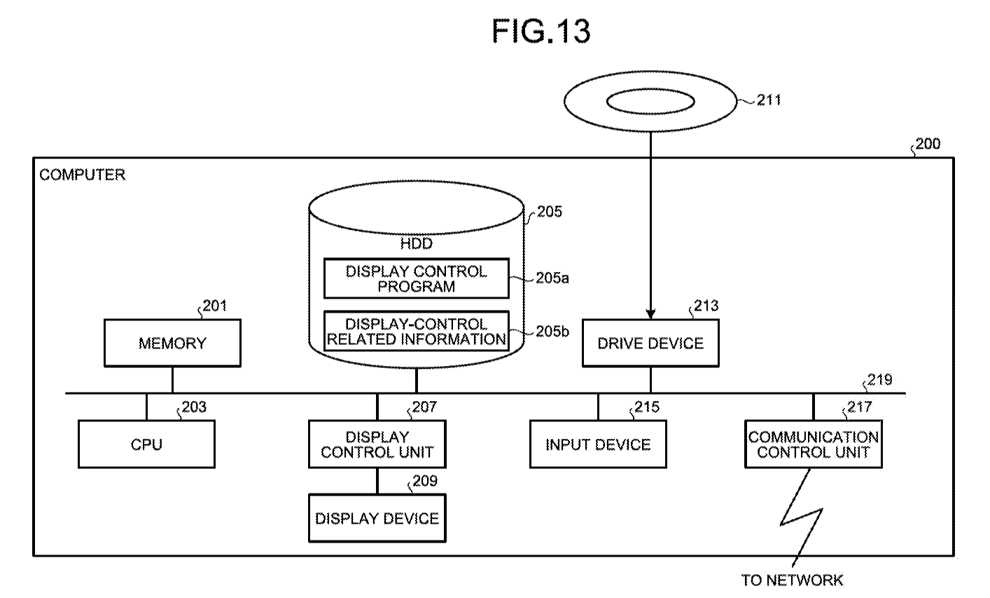

The various types of processes described in the above embodiment can be realized by executing a program prepared in advance by a computer such as a personal computer or a workstation. In the following descriptions, an example of a computer that executes an operation management program for realizing functions identical to those of the display control server 1 illustrated in FIG. 1 is explained. FIG. 13 is a diagram illustrating an example of a computer that executes a display control program.

As illustrated in FIG. 13, a computer 200 includes a CPU 203 that performs various types of arithmetic processing, an input device 215 that receives input of data from a user, and a display control unit 207 that controls a display device 209. The computer 200 also includes a drive device 213 that reads a program or the like from a storage medium, and a communication control unit 217 that transfers data between the computer 200 and other .computers via a network. The computer 200 also includes a memory 201 that temporarily stores therein various types of information and an HDD 205. The memory 201, the CPU 203, the HDD 205, the display control unit 207, the drive device 213, the input device 215, and the communication control unit 217 are connected to each other via a bus 219.

For example, the drive device 213 is a device used for a removable disk 211. The HDD 205 stores a display control program 205a and display-control related information 205b.

The CPU 203 reads out the display control program 205a, loads the display control program 205a in the memory 201, and executes the program as a process. The process corresponds to the respective functional units of the display control server 1. The display-control related information 205b corresponds to the container management table 131, the customer management table 132, the distribution rule table 133, and the image 134. Subsequently, for example, the removable disk 211 stores therein various pieces of information such as the display control program 205a.

The display control program 205a does not need to be stored in the HDD 205 in advance. It is possible to configure that, for example, the program is first stored in a “mobile physical medium” such as a flexible disk (FD), a CD-ROM, a DVD disk, a magneto optical disk, and an IC card inserted to the computer 200, and then the computer 200 reads the display control program 205a from such a physical medium and executes the program.

According to an aspect, it is possible to send individual pieces of information to each of individual users.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control method comprising:
receiving registration of a target image to be displayed on a display of a container, by a processor;
upon acquisition of identification information of a container or a display of the container, transmitting the registered image to a destination associated with the identification information, by the processor; and
displaying the image on the display of the container, by the processor.

2. The display control method according to claim 1, wherein the image is letters or figures.

3. A non-transitory computer-readable recording medium storing therein a display control program that causes a computer to execute a process comprising:
upon start of usage or purchase completion of a specific object that displays data, acquiring information of a user or a purchaser of the object;
storing the acquired information of the user or the purchaser in association with identification information of the object in a storage; and
displaying data corresponding to information of the user or the purchaser stored in the storage on the object.

4. The computer-readable recording medium according to claim 3, wherein the process further includes changing data to be displayed on the object according to an elapsed time since a start timing of usage of the specific object or a purchase timing of the specific object.

5. The computer-readable recording medium according to claim 3, wherein the process further includes changing data to be displayed on the object according to information from a sensor attached on the specific object.

6. The computer-readable recording medium according to claim 3, wherein the information of the user or the purchaser includes information of an object that the user or the purchaser used and/or purchased in past.

7. The computer-readable recording medium according to claim 3, wherein the process further includes determining and outputting whether new usage and/or purchase has been made by using data displayed on the object.

8. A display control method comprising:
upon start of usage or purchase completion of a specific object that displays data, acquiring information of a user or a purchaser of the object, by a processor;
storing the acquired information of the user or the purchaser in association with identification information of the object in a storage, by the processor; and
displaying data corresponding to information of the user or the purchaser stored in the storage on the object, by the processor.
